(19) United States
(12) Patent Application Publication
(10) Pub. No.: US 2011/0179887 A1
(43) Pub. Date: Jul. 28, 2011

(54) SAMPLE ACQUISITION DEVICE

(76) Inventors: Paul J. Cobian, Woodbury, MN (US); G. Marco Bommarito, Stillwater, MN (US); Bernard A. Gonzalez, St. Paul, MN (US); Tushar A. Kshirsagar, Woodbury, MN (US); Patrick A. Mach, Shorewood, MN (US); Tera M. Nordby, Woodbury, MN (US); Gustavo H. Castro, Cottage Grove, MN (US); Joseph J. Stoffel, Hastings, MN (US); Murat Okcay, Waterloo, IA (US); Scott A. Burton, Woodbury, MN (US)

(21) Appl. No.: 12/867,100

(22) PCT Filed: Feb. 12, 2009
(86) PCT No.: PCT/US09/33869

§ 371 Date: Mar. 28, 2011

Related U.S. Application Data
(60) Provisional application No. 61/029,087, filed on Feb. 15, 2008.

(51) Int. Cl. G01N 1/10

(52) U.S. Cl. 73/864

(57) ABSTRACT

A sample acquisition device includes a body comprising a plurality of sample acquisition regions defined by at least a first wall and a second wall oriented nonparallel to the first wall. In some embodiments, the body defines a plurality of apertures that define a plurality of sample acquisition regions. In other embodiments, the walls extend from the body, and the sample acquisition regions are defined between the walls. The sample acquisition regions may be configured in some embodiments such that a user may acquire a sample by rotating the body in a first direction relative to a sample source and may release the sample by rotating the body in a second direction that is substantially opposite to the first direction. When rotated in the first direction, at least one of the first or second walls defines a surface that is inclined into a sample acquisition region.

### CROSS REFERENCE TO RELATED APPLICATIONS

This application claims the benefit of U.S. Provisional Application Ser. No. 61/029,087, filed Feb. 15, 2008, which is incorporated herein by reference.

### TECHNICAL FIELD

The invention relates to sample analysis, and, more particularly, a sample acquisition device.

### BACKGROUND

A biological specimen from a living (e.g., a human patient) or nonliving source (e.g., a food preparation surface) may be obtained via a sample acquisition device for bioburden testing. Bioburden testing may include, for example, the determination of the number of organisms with which the specimen is contaminated. For example, a sample from a patient's open wound may be acquired in order to determine whether the wound is contaminated with potentially hazardous microorganisms.

One type of conventional sample acquisition device is a medical swab with a fibrous nonwoven tip at one end of a stem. A user may manually handle the swab by grasping the stem and placing the swab tip in contact with selected tissue cells or other biological specimens, e.g., from within the ear, nose, throat or open wound of a patient. Some of the targeted tissue cells or biological specimen adheres to the swab tip, thereby defining a biological sample for analysis. Tests that may be performed with the acquired sample include, for example, fluorescent tests, enzymatic tests, monoclonal based tests, agglutination tests, and the like.

### SUMMARY

In general, the invention is directed to a sample acquisition device including a body defining a plurality of sample acquisition regions between at least a first wall and a second wall oriented generally nonparallel to the first wall. In one embodiment, the second wall defines a sloped surface into the sample acquisition region when the body is rotated in a first direction. The sample acquisition regions may be defined by, for example, a plurality of apertures defined by the body, a plurality of projections extending from the body or any combination of apertures or projections. In some embodiments, the apertures comprise a plurality of elongated grooves that extend in a direction substantially along a length of an elongated body of the sample acquisition device. In other embodiments, the apertures comprise truncated openings that may be arranged in rows or in an irregular pattern. In other embodiments, the sample acquisition regions are defined between a plurality of projections extending from the body, where the projections may extend in one or more directions.

In one embodiment of a technique for acquiring a sample with a sample acquisition device described herein, a user may place the body of the sample acquisition device in contact with a sample source and rotate the body in a first direction. The user may apply pressure to further engage the body with a sample surface of the source. As the body is rotated in the first direction, sample particles are captured in at least some of the sample acquisition regions. The sample may be any suitable state, and is not limited to a liquid or solid state. In embodiments in which at least one of the sample acquisition regions comprises a wall that provides an inclined surface into the sample acquisition region when the body is rotated in the first direction, the sloped wall encourages sample particles to move into the sample acquisition region.

In some embodiments, the first and second walls of the sample acquisition region may remove sample particles from the sample source by an abrasive action. In other embodiments, the sample acquisition regions receive sample particles by capillary force in addition to or instead of abrasive action.

In some techniques for removing the sample from the sample acquisition device, the user may introduce the body into a buffer solution and rotate the body in a second direction that is substantially opposite to the first direction. Some bodies described herein include sample acquisition regions that are configured to release the sample with less energy when rotated in the second direction compared to rotating in the first direction.

In one embodiment, the invention is directed to a sample acquisition device comprising a stem and a body coupled to the stem and defining a plurality of sample acquisition regions. At least one of the sample acquisition regions is defined between at least a first wall and a second wall oriented generally nonparallel to the first wall.

In one embodiment, the invention is directed to a sample acquisition device comprising a stem defining a longitudinal axis and a body coupled to the stem and defining a plurality of apertures disposed at various lateral positions around the body. At least one of the apertures comprises at least a first wall and a second wall, where the second wall defines a surface that is inclined into the respective aperture when the body is rotated in a first direction about the longitudinal axis of the stem.

In another embodiment, the invention is directed to a method comprising placing a body of a sample acquisition device in contact with a sample source to acquire a sample, the body defining a plurality of sample acquisition regions, where at least one of the sample acquisition regions comprises a first wall and a second wall oriented nonparallel to the first wall, and rotating the body relative to the sample source in a first direction to acquire the sample in at least one of the sample acquisition regions.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic perspective view of one embodiment of a sample acquisition device.

FIGS. 2A-2D illustrate various views the body of the sample acquisition device shown in FIG. 1.

FIG. 3 is a schematic cross-sectional illustration of the sample acquisition device shown in FIG. 1 acquiring a sample from a sample surface.

FIG. 4 is a flow diagram illustrating a technique for acquiring a sample with a sample acquisition device described herein.

FIGS. 5A-5C are a schematic perspective view, cross-sectional view, and partial top view, respectively, of another embodiment of a body of a sample acquisition device.

FIG. 6A is a schematic perspective view of another embodiment of a sample acquisition device including a plurality of grooves defining sample acquisition regions.

FIG. 6B is a plan view of one of the grooves of the body shown in FIG. 6A.

FIG. 6C is a schematic cross-sectional view of the body shown in FIG. 6A taken along line 6C-6C in FIG. 6A.

FIGS. 7A and 7B are a schematic perspective view and top view, respectively, of another embodiment of a sample acquisition device including a plurality of grooves.

FIGS. 8A and 8B illustrate a schematic perspective view and top view, respectively, of an embodiment of a body of a sample acquisition device that includes a plurality of projections defining sample acquisition regions.

FIG. 9 is a schematic perspective view of another embodiment of a body of a sample acquisition device that includes a plurality of projections defining sample acquisition regions.

FIGS. 10A-10B are a schematic perspective view and top view, respectively, of another embodiment of a body of a sample acquisition device.

FIG. 11 is a schematic perspective view of another embodiment of a body of a sample acquisition device.

FIG. 12 is a schematic perspective view of a device that includes a motor to automatically rotate a sample acquisition device.

FIG. 13 is a chart illustrating the results of various experiments comparing the volume of sample acquired by a convention cotton swab to different embodiments of sample acquisition devices in accordance with the invention.

### DETAILED DESCRIPTION

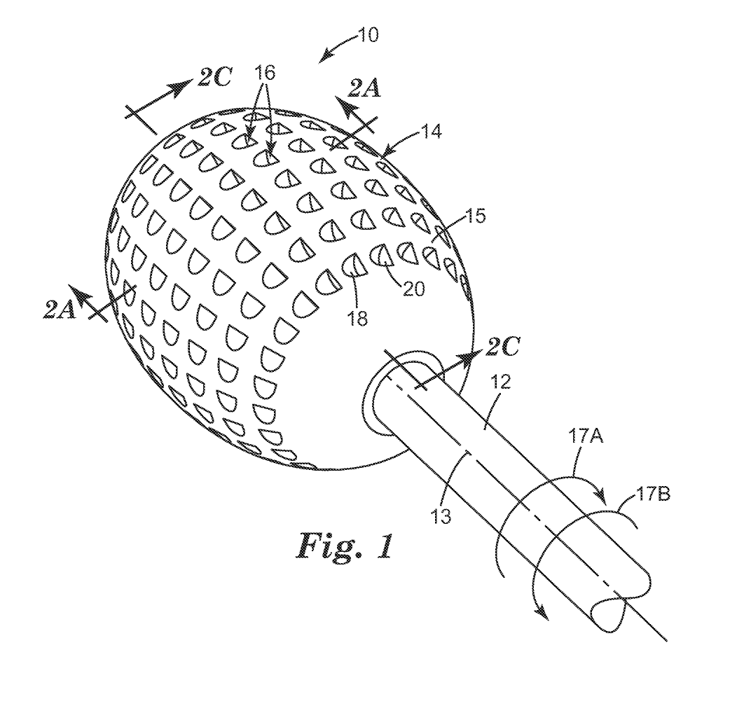

FIG. 1 is a perspective view of sample acquisition device 10, which includes stem 12 and body 14 defining a plurality of apertures 16. Each aperture 16 defines a sample acquisition region that includes at least a first wall and a second wall that is generally nonparallel to the first wall. Sample acquisition device 10 may be used to acquire a sample from a sample source. As described in further detail below, a user may place body 14 in contact with a sample source and rotate body 14 in a first direction, which is indicated by arrow 17A, in order to obtain a sample from the source. The sample may be liquid, solid or any state between a liquid and solid.

In some embodiments, apertures 16 are configured to remove sample particles from a sample source by abrasive action, which results when body 14 is engaged with the sample source and rotated in the first direction 17A. In other embodiments, apertures 16 are configured to receive sample particles by capillary force in addition to or instead of the abrasive action. The sample source may be from a living or nonliving patient. Examples of living sources include, but are not limited to, a human patient's wound, ear, nose, throat, and the like. Examples of nonliving sources include, but are not limited to, a food preparation surface or utensil.

The sample acquired via sample acquisition device 10 may be utilized for any suitable purpose. For example, in one embodiment, the sample may be tested for bioburden, e.g., the number of microorganisms present in the sample, or for the presence of target microorganisms (e.g., staphylococcus aureus). Other example procedures that may be conducted with the sample acquired via sample acquisition device 10 includes preparation of a biological sample for, for example, DNA sequencing, and/or detection, diagnostic or analytical procedures, chemical, biological or biochemical reactions, and the like. Examples of such reactions include detection via thermal processing techniques, such as, but not limited to, enzyme kinetic studies, homogeneous ligand binding assays, and more complex biochemical or other processes that require precise thermal control and/or rapid thermal variations. Other examples of tests performed with an acquired sample include fluorescent tests, enzymatic tests, monoclonal based tests, agglutination tests, and the like.

Stem 12 may be any suitable elongated member that defines a structure that a user may manually grasp in order to place body 14 in contact with a sample source. Stem 12 may be formed of any suitable material that exhibits sufficient rigidity to enable the user to control the position of body 14 and rotate body 14 relative to a sample source. For example, stem 12 may be formed of paper (e.g., cardboard), a polymer, steel (e.g., stainless steel), a metal alloy, and the like. In some embodiments, sample acquisition device 10 is disposable after minimal use, e.g., one use. Accordingly, in some cases, the material for stem 12 and body 14 may be selected to minimize the cost of the device 10.

Body 14 may be any suitable structure that defines a plurality of apertures 16. In some embodiments, body 14 is essentially non-absorbent or non-absorbent with respect to the sample with which body 14 is used to acquire. In addition, in some embodiments, body 14 is made at least in part of a material that exhibits some compliancy (v. rigidity) relative to the sample source. The compliancy of body 14 relative to the sample source may help minimize damage to the sample source, while enabling body 14 to remove sample particles from the sample source by abrasive action. For example, body 14 may be formed at least in part of nylon, metal or a polymer, such as polysulfone, polypropylene, polytetrafluoroethylene (PTFE), polyacrylates, polyethylene, polyvinylidene difluoride (PVDF) or polycarbonate. In some embodiments in which body 14 acquires a sample by abrasive action, it may be desirable for body 14 to exhibit a sufficient level of hardness to enable a user to press body 14 toward the sample source and generate friction between body 14 and the sample source, e.g., to abrade sample particles from the source by a scraping action.

In some embodiments, body 14 may be formed from a thermoplastic materials suitable for casting, profile extrusion, molding, solid freeform fabrication or embossing including, such as, but not limited to, polyolefins, polyesters, polyamides, poly(vinyl chloride), polymethyl methacrylate, polycarbonate, nylon, and the like. Other sample acquisition characteristics of the material forming body 14 may include substantial inertness relative to the sample or a relatively low rate of elution of chemicals or other contaminants that may affect a sample analysis process, e.g., when the sample is released from body 14.

As previously described, in some embodiments, body 14 acquires a sample by capillary force in addition to abrasive action. For example, apertures 16 may each define a capillary structure that obtains and retains a sample from a sample source by capillary pressure. Alternatively, two or more of apertures 16 may be in fluid communication to define a common capillary structure. Accordingly, in some cases, a material for body 14 may be selected to have a particular surface energy to achieve capillary action to draw the sample into apertures 16. The surface energy may be selected based upon the surface energy of the sample that is acquired by device 10.

In some embodiments, body 14 is formed of a material having a surface energy in a range of about 40 dynes/centimeter squared (dyn/cm²) to about 82 dyn/cm², such as about 50 dyn/cm² to about 72 dyn/cm². In some embodiments, the material for body 14 is selected to have a surface energy close to that of water, or about 72 dyn/cm². In some embodiments, body 14 may include a base material that does not necessarily include the desired sample acquisition characteristics, and an external layer (e.g., a coating) comprising a material that affords hydrophilic, hydrophobic, positively-charged or negatively-charged surfaces to achieve the desired sample acquisition characteristics. For example, an inorganic coating (e.g., a silica coating) or an organic coating (e.g., polymeric coatings, such as polyacrylate) may afford hydrophilic characteristics to apertures 16. Surface energy (or surface tension) characteristics of a material forming body 16 may also be achieved with the aid of physical treatments, such as, but not limited to, corona treating in which the material being treated is exposed to an electrical discharge, or corona, electron beam treatments.

A sample that is retained within apertures 16 by capillary force may be easier to remove from body 14 compared to a conventional medical swab that includes a fibrous tip because the sample is held within apertures 16 by adsorption, rather than absorption, as is the case with some conventional medical swabs. For example, less energy may be required to release the sample particles from apertures 16 compared to sample particles that are bound to fibers of a conventional medical swab.

In the embodiment shown in FIG. 1, body 14 defines a rounded outer surface 15. Distribution of apertures 16 across a rounded surface 15 of body 14 provides a greater variety of distances, angles, and surface contact between apertures 16 and a target sample acquisition site. Some sample sources may define an irregular, nonplanar surface, and the sample surface may differ between patients (in the case of living sample sources). Increased spatial diversity among the apertures 16 may increase the likelihood that at least some of apertures 16 will engage with the sample source, thereby increasing the likelihood of acquiring a sufficient quantity of sample.

Apertures 16 define a plurality of sample acquisition regions that capture and contain the sample. The shape of each of apertures 16 may be circular, oval, rectangular, square, or irregular. In the embodiment shown in FIG. 1, each aperture 16 includes a first wall 18 that is substantially planar and a second wall 20 that is substantially curvilinear. Accordingly, in the embodiment shown in FIG. 1, apertures 16 each define a “D” shape at outer surface 15 of body 14. As described in further detail below, second wall 20 defines a surface that is inclined into aperture when body 14 is rotated in the first direction 17A. Thus, second wall 20 defines an aperture surface that encourages entry of sample particles into the respective aperture 16 when a user rotates body 14 in first direction 17A while body 14 is engaged with the sample source. In addition, the junction between angled wall 20 and outer surface 15 of body 14, as well as the junction between first wall 18 and outer surface 15 of may help generate friction between body 14 and the sample surface. The friction may help apertures 16 capture particles from the sample source by abrasive action, e.g., by scraping a surface of the sample source.

Apertures 16 may be sized to retain a maximum sample volume in order to meter the quantity of sample a user may obtain with sample acquisition device 10. Controlling the maximum volume of sample acquired with sample acquisition device 10 may help minimize variability in sample size attributable to different users or user techniques for handling device 10. The maximum sample volume may be selected, for example, based on the sample analysis tests performed with the sample. Some sample analysis processes are sensitive to sample quantities, and, accordingly, a device 10 that helps a user meter the quantity of sample obtained may be useful. In the embodiment shown in FIG. 1, apertures 16 each define a volume of about 3 microliters (μL) to about 10 μL, enabling sample acquisition device 10 to capture a maximum sample volume of about 10 μL to about 1000 μL, such as about 10 μL to about 500 μL. Other maximum sample volumes are contemplated.

Sample acquisition device 10 provides advantages over conventional medical swabs that are often used to acquire a sample from a source for further analysis. Conventional medical swabs typically include a fibrous non-woven tip in a teardrop or ellipsoidal shape at one end of a stem. Typically, a user manually grasps the stem of the medical swab and places the fibrous tip in contact with the select tissue cells or other specimen to be obtained, e.g., from within a wound, ear, nose or throat of a human patient. Some of the targeted specimen adheres to the fibrous swab tip.

The conventional tip of the swab typically has a relatively large sample acquisition surface area to volume held by the swab, thereby increasing the possibility of the specimen binding to the fibers of the swab tip and being unavailable for sample analysis. Variability in the composition of the nonwoven material (e.g., rayon) of the fibrous swab tip, which may result from the type of nonwoven material and the construction of the swab, as well as variability in the user technique employed to acquire the sample may affect the quantity of sample that adheres to the swab tip. For example, depending on the user or the particular batch of swabs used to acquire a sample, the quantity of sample acquired by two different swabs may differ. As one example, the fibers forming the tip of a conventional swab may differ in absorption characteristics or in an ability to bind to sample particles from batch to batch. The variance in sample size may affect the quality of sample analysis. Some sample analysis techniques may provide substantially inaccurate or varying if a sample size is not within a particular range. Thus, sample acquisition by conventional swabs may adversely affect some sample analysis techniques.

In contrast to a conventional sample acquisition device, sample acquisition device 10 is designed to minimize variability in acquired sample volume that may be attributable to different acquisition techniques (e.g., based on different users) or different batches of devices. As previously described, apertures 16 of sample acquisition device 10 are designed to acquire a substantially fixed quantity of a sample from a sample source. Apertures 16 are designed to hold a maximum volume of a sample, which may meter the volume of sample a user acquires. Some detection techniques that provide different results based on the quantity of sample analyzed, thus, it may be desirable to acquire a particular sample volume.

In some embodiments, such as embodiments in which body 14 is manufactured by an injection molding process, variance in the size of apertures 16 may be minimized, thereby minimizing variance in sample volume that may be attributable to the batch of sample acquisition devices 10. In addition, the quantity of chemicals that may contaminate or interfere with the analysis of the acquired sample may be minimized embodiments in which body 14 is comprised of a polymer or steel. On the other hand, the fibrous tip of medical swabs may include chemicals transfer to the sample when the sample is eluted from the swab. These chemicals may contaminate or interfere with the analysis of the sample. For example, some fibrous swab tips may include various adhesives (e.g., to adhere the fibrous material to a stem), binders, surfactants, processing aids, and soluble oligomers that interfere with a detection technique.

Depending upon the construction of the medical swab, fibers from the fibrous tip may transfer to the sample source, which may be undesirable. For example, in the case of an open wound in a human patient, transfer of fibers from the medical swab to the open wound may agitate the wound, and in some cases, encourage infection of the wound. As another example, contaminating a food preparation surface with fibers may increase the risk of transferring fibers to food placed on the surface. Body 14 is formed of a material that exhibits fewer transferable chemicals compared to a fibrous tip of a conventional swab, and, accordingly, the possibility of the material of body 14 contaminating a sample or interfering with analysis of a sample is decreased when a sample is acquired via sample acquisition device compared to a convention swab including a fibrous tip.

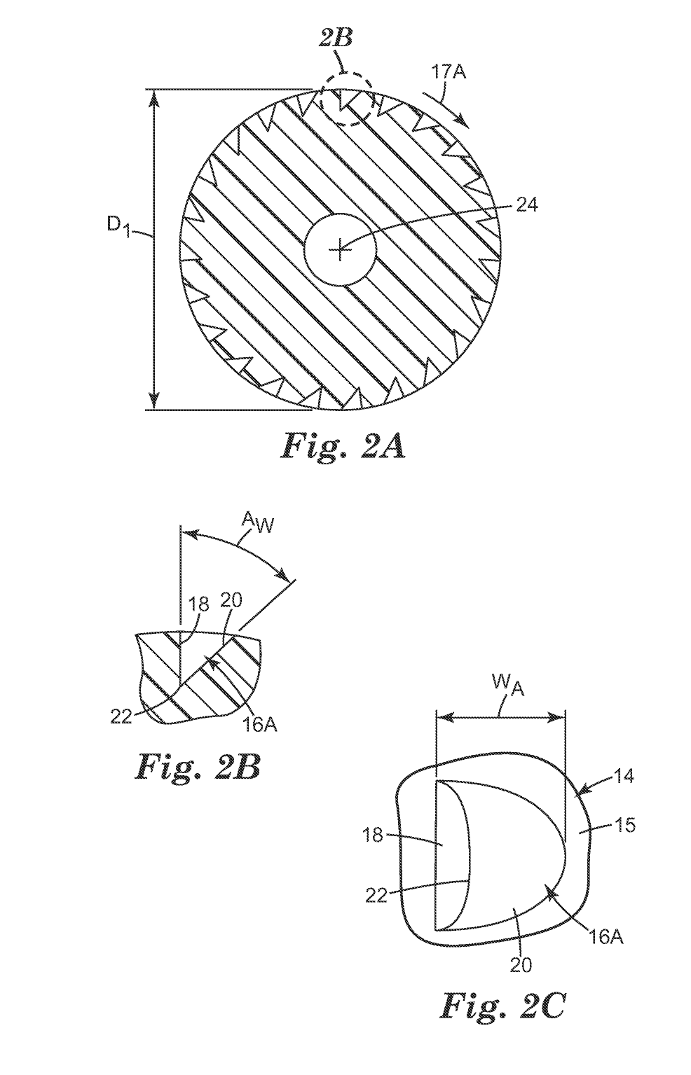

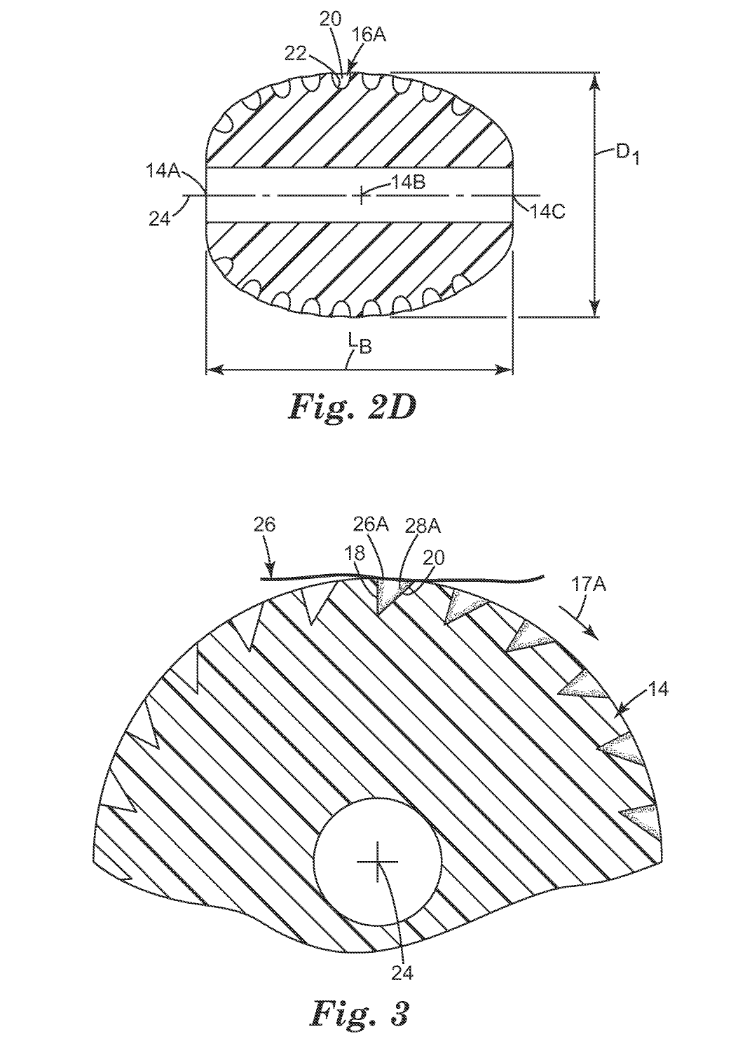

FIG. 2A is a schematic cross-sectional view of body 14 taken along line 2A-2A in FIG. 1, and FIG. 2B illustrates details of aperture 16A (also shown in FIG. 2A), which is representative of each of the other apertures 16. FIG. 2C is a schematic top view of body 14, illustrating aperture 16A and outer surface 15 of body 14. FIG. 2D is a schematic cross-sectional view of body 14 taken along line 2D-2D in FIG. 1.

Aperture 16A includes first wall 18 and second wall 20, which are defined by body 14. As shown in the top view of aperture 16A, shown in FIG. 2C, second wall 20 is curvilinear, while first wall 18 is substantially planar. In the embodiment shown in FIG. 2A, walls 18, 20 are separated by a width W_{A} at outer surface 15 of body 14 and meet at junction 22. Thus, walls 18, 20 define a junction 22 that traverses substantially along a bottom surface of aperture 16A, where “bottom” may generally refer to the surface within aperture 16A that is furthest from outer surface 15 of body 14. As shown in FIG. 2D, junction 22 is not substantially straight, but is curvilinear.

As shown in FIG. 2B, walls 18, 20 may meet at a rounded junction 22, rather than a sharp (or pointed) junction. Compared to a pointed junction (e.g., an apex of a triangle), rounded junction 22 defines a surface that is more conducive to releasing sample particles. For example, if walls 18, 20 converged at a sharp point at junction 22, sample particles may get stuck in the small space defined at between walls 18, 20 at the sharp point. On the other hand, walls 18, 20 that are joined by a curvilinear surface increases the space between walls 18, 20 at junction 22, thereby minimizing the possibility of sample particles remaining bound within aperture 16A when a user attempts to release the sample from body 14. In other embodiments, walls 18, 20 may converge at a sharp point.

At the widest point W_{A} of aperture 16A measured along top surface 15 of body 15, (shown in FIG. 2C), walls 18 and 20 are generally oriented at an angle A_{W} relative to each other. In the embodiment shown in FIG. 2A, angle A_{W} is less than 180°, such that walls 18, 20 are generally nonparallel. In some embodiments, angle A_{W} may be between about 20° to about 160°, such as about 45 to about 135°. In addition, walls 18 and 20 may be oriented such that they are nonparallel to a plane in which longitudinal axis 24 lays.

In the embodiment shown in FIGS. 1-2D, wall 20 is oriented such that it defines a surface that is inclined into aperture 16A. FIG. 3 is a schematic illustrating of body 14 engaged with sample surface 42. As body 14 is rotated in first direction 17A about center axis 24 of body 14 and engaged with sample surface 26, which may be, for example, a mucosal lining in a patient's nasal cavity, wall 20 of aperture 16A defines a surface that encourages a portion of tissue 26A to be drawn into aperture 16A. As the user engages body 14 with sample surface 26 and rotates body 14, friction is generated between body 14 and sample surface 26, which helps wall 18, and, in some cases, wall 20, of body 14 scrape or scoop sample particles 28 into aperture 16A. Although individual particles 28 are shown in FIG. 2D, in other embodiments, particles 28 may not define individual particles, and may have, for example, the consistency of a fluid.

Bacteria present in a human patient's nasal cavity may be embedded within a nasal biofilm, which may have the consistency of a gel or another nonliquid state. It may be difficult to capture the biofilm with conventional swabs (or “swab applicators”) that include a fibrous bud composed of cotton, rayon or other fibers. While these swabs may be useful for retaining liquid samples, in the case of the nonliquid biofilm, the conventional swab tip may merely spread the biofilm around while capturing a minimal amount, if any, of the biofilm. In contrast, sample acquisition device 10 includes a body 14 defining a plurality of sample acquisition regions 16 that may capture and retain the biofilm or another nonliquid sample.

In cases in which sample surface 26 is not compliant (e.g., a stainless steel food preparation counter), a portion of sample surface 26 may not be drawn into aperture 16A. Nevertheless, the inclined surface defined by wall 20 opens aperture 16A towards the sample surface and encourages the entry of sample particles into aperture 16A as the particles are scraped or otherwise removed from the sample surface by body 14.

Returning now to FIG. 2D, a cross-sectional view of body 14 taken along a plane substantially parallel to a center longitudinal axis 13 of stem 12 (FIG. 1) or a center axis 24 of body 14 defines an elongated, substantially ovoid shape with a greatest length L_{B}. In some embodiments, length L_{B} may about 3 millimeters (mm) to about 100 mm, such as about 15 mm. However, length L_{B} may be modified to accommodate a particular sample source. For example, if device 10 is intended to be used to acquire a sample from a nasal cavity of a human patient, length L_{B} may be about 3 mm to about 15 mm. Body 14 has diameter that increases from a proximal end 14A to a maximum diameter at the approximate midpoint 14B along length of L_{B} body 14, and increases from a distal end 14C to a maximum diameter at the approximate midpoint 14B along length L_{B} of body 14. Thus, body 14 defines a proximal portion between proximal end 14A and midpoint 14B and a distal portion between midpoint 14B and distal end 14C. In the embodiment shown in FIG. 2D, apertures 16 are positioned along both the proximal portion and distal portion of body 14.

In the embodiment shown in FIGS. 1-2D, body 14 has a rounded outer surface 15 that has a substantially circular cross-section at its widest point. In some embodiments, the maximum cross-sectional diameter D₁ (FIG. 2A) of body 14 taken at midpoint 14B of length L_{B} in a plane substantially perpendicular to the longitudinal axis 24 of body 14 may be about 1 mm to about 20 mm, such as about 15 mm. Just as with length L_{B} of body 14, diameter D₁ of body 14 may be modified to accommodate a particular sample source. In other embodiments, body 14 may have a cross-sectional shape with an irregular or noncircular shape.

While a generally ovoid body 14 is shown in FIGS. 1-2D, in other embodiments, body 14 may define another shape, such as a spherical or partially spherical surface. In other embodiments, outer surface 15 may be substantially planar, rather than rounded. In addition, in other embodiments, walls 18, 20 may have other configurations. For example, second wall 20 may be substantially planar, rather than curvilinear, and/or first wall 18 may be curvilinear. Alternatively, one or more of walls 18, 20 may comprise multiple planar or curvilinear surfaces.

As previously described, a sample retained by body 14 may be subsequently analyzed for detection of a particular microorganism or another sample analysis process. In some cases, the sample is combined with a reagent for a subsequent sample preparation or analysis process. In some embodiments, body 14 may include one or more reagents or other chemicals that are used in a subsequent sample preparation or analysis process. For example, the reagent may be coated or otherwise applied within apertures 16. Thus, when the sample is drawn into apertures 16, the sample may begin reacting with the reagent.

In some embodiments, body 14 may include a reagent such as, but are not limited to, a lysis reagent (e.g., lysostaphin, lysozyme, mutanolysin or other enzymes), a protein-digesting reagent, a nucleic acid amplifying enzyme, an oligonucleotide, a probe, nucleotide triphosphates, a buffer, a salt, a surfactant, a dye, a nucleic acid control, a nucleic acid amplifying enzyme, a reducing agent, dimethyl sulfoxide (DMSO), glycerol, ethylenediaminetetraacetic acid (EDTA), ethylene glycol-bis(2-aminoethylether)-N,N,N′,N′-tetraacetic acid (EGTA), microspheres capable of binding a nucleic acid, and a combination thereof. In addition, in some embodiments, the reagent is selected from a group including RNase, DNase, an RNase inhibitor, a DNase inhibitor, Bovine Serum Albumin, spermidine, and a preservative. Other reagents may include salts, buffers that regulate the pH of reaction media involved in the sample analysis or preparation, dyes, detergents or surfactants that lyse or de-clump cells, improve mixing or enhance fluid flow.

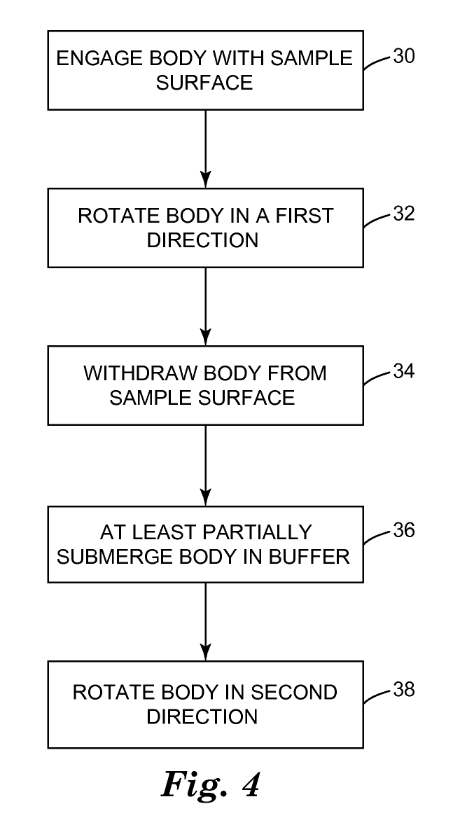

FIG. 4 is a flow diagram illustrating an embodiment of a technique for acquiring a sample with sample acquisition device 10 of FIGS. 1-2D. A user may place body 14 in contact with a sample source, such as by introducing body 14 into an cavity if a living patient (e.g., a nasal canal, ear, mouth). After engaging body 14 with a surface of the sample source (30), the user may rotate body 14 in first direction 17A (32), such as by rotating stem 12, in order to place various regions of outer surface 15 of body 14 in contact with the sample source. Body 14 may be rotated manually or with the aid of an automated rotating device.

As described above, when body 14 is rotated in a first direction, sample particles, regardless of the state (e.g., liquid or solid) of the sample, are received in at least some of apertures 16 by abrasive action (e.g., mechanical scraping of the particles into the apertures 16), by capillary force or combinations thereof. The user may rotate body 14 any suitable number of times. In some embodiments, body 14 may be rotated one or less than one full rotation while engaged with the sample source in order to acquire the sample. In other embodiments, body 14 may be rotated multiple times.

The user may also place different portions of outer surface 15 of body 14 in contact with the sample surface. Because outer surface 15 of body 14 has a proximal portion and distal portion with varying radii (in the cross-section taken substantially perpendicular to center axis 24 of body 14), the entire outer surface 15 may not simultaneously contact the sample source if the sample source defines, e.g., a generally planar surface. Accordingly, in some cases, the user may reorient center axis 24 of body 14 relative to the sample source in order to reposition outer surface 15 relative to a surface of the sample source.

After acquiring the sample, the user may withdraw body 14 from the sample surface (34). In some cases, the user may protect body 14 from contaminants, e.g., with a cap for storage or transportation to a sample analysis site. Alternatively, the user may release the sample from body 14. In the technique shown in FIG. 4, a releasing technique includes at least partially submerging body 14 in a buffer solution (36). For example, the user may submerge apertures 16 that were exposed to the sample source and swirl body 14 around in the buffer solution. The buffer solution may be a substantially liquid solution, which may include, for example, reagents or other chemicals that react with the sample, e.g., as apart of a sample analysis process. Once submerged in the buffer solution, at least some of the sample may be released from apertures 16. In order to elute a larger percentage of the sample, the user may rotate body 14 in a second direction 17B within the buffer solution (38). As previously described, the second direction 17B is substantially opposite the first direction 17A.

While the user may also rotate body 14 in the first direction 17A or agitate body 14 within the buffer solution in a nonspecific pattern, it is believed that in some embodiments, the configuration of apertures 16 are conducive to releasing a sample when body 14 is rotated in the second direction 17B, i.e., in a direction substantially opposite to the direction in which the respective wall 20 of each aperture 16 is angled. That is, in some embodiments, less energy is required to release the sample from apertures 16 when body 14 is rotated in the second direction 17B. This may be partially attributable to the inclined surface defined by wall 18. Just as wall 20 defines a surface that is inclined into aperture 16 when body 14 is rotated in the first direction 17A, the surface defined by wall 20 may also help guide sample particles out of apertures 16 when body 14 is rotated in the second direction 17B.

As previously described, in some embodiments, body 14 may be formed form a material, such as a polymer, that minimizes or eliminates the amount of a liquid buffer solution that body 14 retains when at least partially submerged in the buffer solution. This may help maximize the amount of sample that is released into buffer solution from apertures 16 and increase the efficiency with which the sample is released from apertures 16. In addition, the material for body 14 may be selected to minimize the amount of additives or other materials released into the buffer solution during the sample release step. In the case of many conventional swabs, the fibers of the conventional swab bud may be coated with carboxy methyl cellulose (CMC) in order to help the fibers hold their bud-like structure. When the conventional swab bud is exposed to a wash solution, the CMC and other additives in the swab bud may be leached out into the wash solution. The CMC and other additives may impact a subsequent sample analysis technique. Body 14 described herein helps minimize or even eliminate the exudates that are released from the sample acquisition device compared to a conventional swab bud.

In some embodiments of sample acquisition device 10, stem 12 may define an inner lumen that is in fluid communication with apertures 16. In order to elute an acquired sample from apertures 16, a user may introduce rinse fluid into the inner lumen defined by stem 12 and into body 14, such that the fluid flows through apertures 16. A flow member, such as a nylon, polycarbonate, PTFE or PVDF membrane, may be disposed between the lumen of stem 12 and body 14 in order to help distribute the fluid across a majority or all of apertures 16.

In some embodiments, a compartment, such as a deformable bulb or syringe, including the rinse fluid (or buffer solution) may be mechanically and fluidically coupled to an opposite end of stem 12 from body 14. In some embodiments, the rinse fluid may include a reagent that is useful for sample preparation or analysis. The fluid compartment may store a volume of rinse fluid that is sufficient to elute substantially all of the sample from apertures 16 as the rinse fluid flows through stem 12 and through apertures 16. For example, the fluid compartment may store a volume of rinse fluid that is about five times to about twenty times the total maximum sample volume apertures 16 are designed to retain. The fluid compartment may include a mechanism to retain the rinse fluid in the compartment until release is desired. For example, a mechanical valve (e.g., a snap valve), laser valve or a membrane that may be ruptured by applying pressure to the membrane may be disposed between the inner lumen of stem 12 and the fluid compartment.

The embodiment of body 14 shown in FIGS. 1-2D comprises more than twenty rows of apertures 16 at various circumferential positions around curvilinear outer surface 15, where the rows extend in generally the same direction as length L_{B} of body 14. Each row comprises about nine apertures. In other embodiments, a body of a sample acquisition device may include other arrangements of apertures 16. For example, a body of a sample acquisition device may include greater than or less than twenty rows of apertures, rows of apertures comprises greater or fewer than nine apertures or apertures 16 may be arranged in an irregular pattern (e.g., not arranged into columns or rows) to define apertures at various circumferential and longitudinal positions, where a longitudinal direction is measured substantially along length L_{B} of body 14. In embodiments in which body 14 does not define a rounded outer surface 15 with a circumference, the apertures of a body may be arranged to define apertures at various lateral and/or longitudinal positions, where a lateral direction is measured substantially perpendicular to length L_{B} of body 14. As used herein, “lateral” position may also refer to a circumferential position.

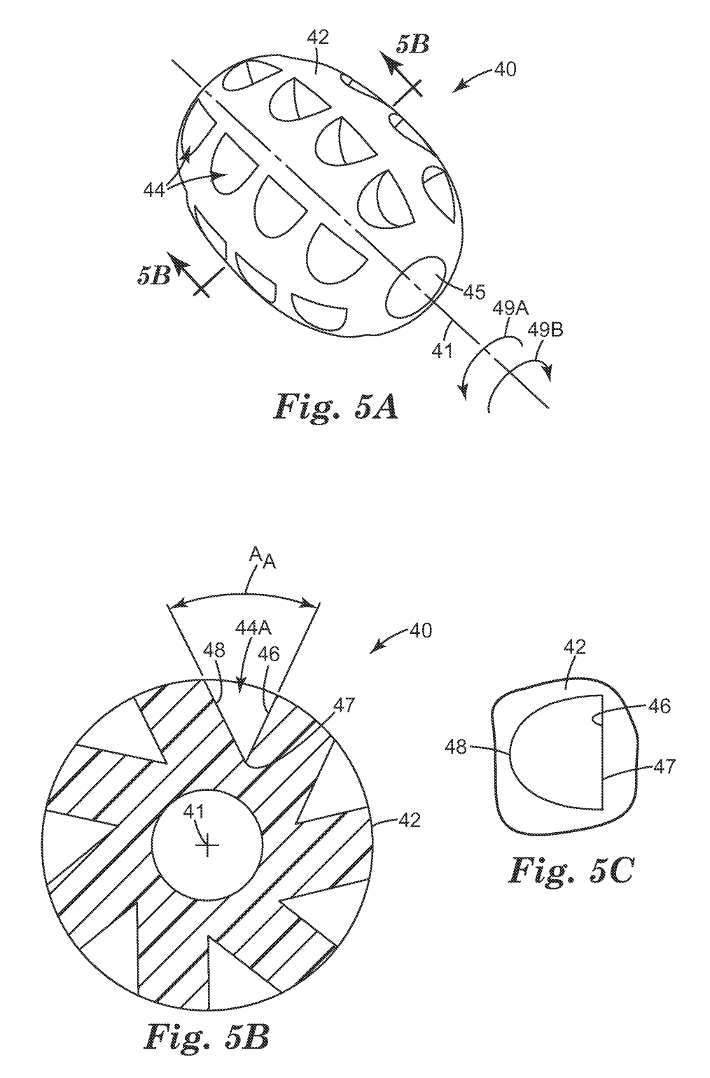

In each of the embodiments of sample acquisition devices shown in FIGS. 5A-10, the sample acquisition regions may be engineered to retain a maximum sample volume in order to meter the quantity of sample a user may obtain with the respective sample acquisition device. For example, the sample acquisition regions may define a total maximum sample volume of about 10 μL to about 1000 μL, such as about 10 μL to about 500 μL. Other maximum sample volumes are contemplated. In addition, each of the sample acquisition devices described herein may acquire a sample by abrasive action, capillary action or both.

FIG. 5A is a schematic perspective view of body 40, which may be coupled to stem 12 (FIG. 1). Body 40 defines a center axis 42 and comprises a rounded outer surface 42. Body 40 defines a plurality of apertures 44 along outer surface 42. Apertures 42 have a similar shape as apertures 16 (FIG. 1). However, body 40 defines six rows of apertures 44 (where the rows extending in a direction substantially along center axis 41 of body 40) that each comprise four apertures 44, rather than including more than twenty rows of apertures as in the embodiment of body 14 shown in FIG. 1. Body 40 defines an opening 45 configured to receive stem 12. Stem 12 and body 40 may couple together by an interference fit between opening 45 and stem 12. In addition or instead of an interference fit between stem 12 and opening 45, an adhesive or welding (e.g., ultrasonic welding) may help secure the mechanical coupling between stem 12 and body 40. In other embodiments, stem 12 and body 40 may be integral (e.g., formed from a common piece of material).

FIG. 5B is a schematic cross-sectional view of body 40 taken along line 5B-5B in FIG. 5A. Aperture 44A, which is representative of the configuration of the other apertures 44, includes first wall 46 and second wall 48. First and second walls 46, 48 are oriented at an angle A_{A} relative to each other. In the embodiment shown in FIG. 5B, angle A_{A} is less than 180°, such that walls 46, 48 are generally nonparallel. In some embodiments, angle A_{A} may be between about 20° to about 160°, such as about 45° to about 135°. First and second walls 46, 48 define a junction 47 that defines a point, rather than a rounded surface as with junction 22 of apertures 16 in FIGS. 1-2D.

FIG. 5C is a schematic top view of body 40 and illustrates aperture 44A and outer surface 42 of body 40. As shown in FIG. 5C, first wall 46 is oriented such that first wall 46 defines a plane that is substantially aligned with junction 47 from the top view of aperture 44A. In the embodiment shown in FIG. 5C, wall 46 defines a plane that is generally parallel to a plane in which longitudinal axis 41 of body 40 lays. Second wall 48 and second wall 20 of FIGS. 1-2D are similarly oriented. When a user rotates body in a first direction 49A, second wall 48 defines a surface that is inclined into aperture 44A. The user may rotate body 40 in a second direction 49B, which is substantially opposite to the first direction 49A, in order to release a sample from aperture 44A. It is believed that less energy is required to release the sample from aperture 44A when body 40 is rotated in the second direction 49B compared to the first direction 49A.

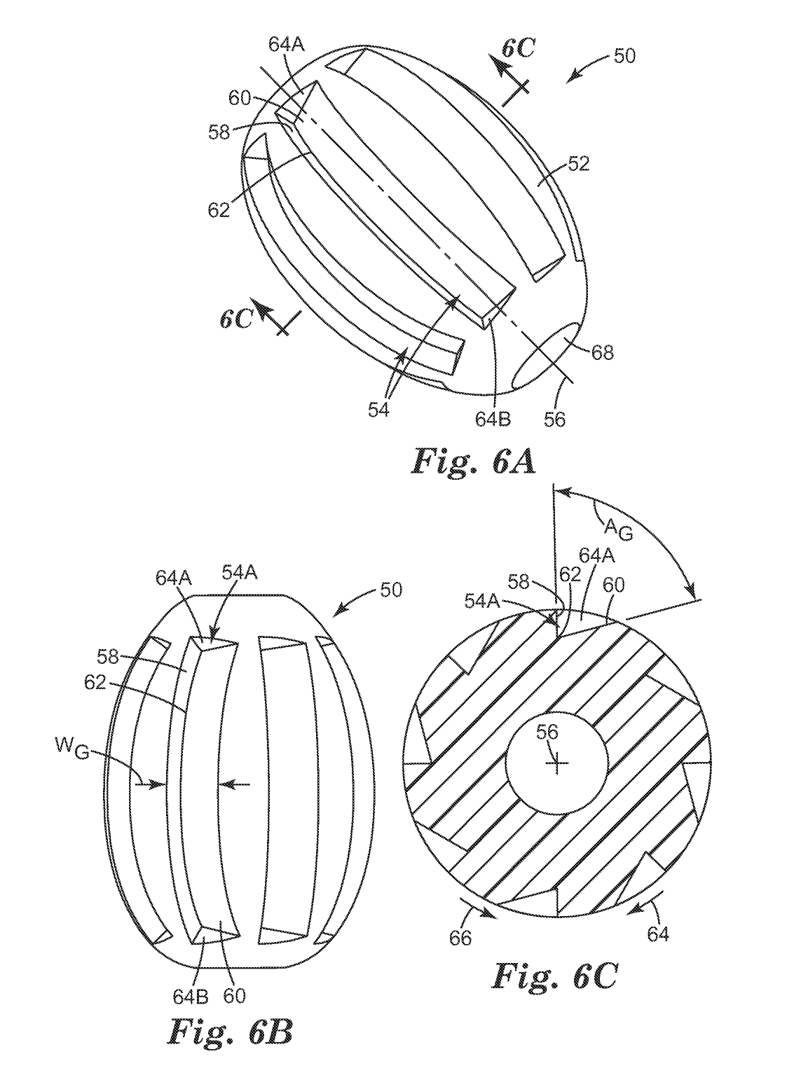

FIG. 6A is a schematic perspective view of another embodiment of body 50, which may be coupled to stem 12. Body 50 has a rounded outer surface 52, which is similar to outer surface 15 of body 14 (FIGS. 1-2D). In addition, body 50 defines a plurality of grooves 54, which have substantially similar shapes, where each groove 54 defines a sample acquisition region. Grooves 54 extend in substantially the same direction as center longitudinal axis 56 of body 50. Grooves 54 extend along a greater length of body 50 (measured along longitudinal axis 56 of body 50) than the apertures 16 shown in FIGS. 1-2D. However, grooves 54 may also be generally referred to as apertures. Each groove 54 includes walls 58 and 60, and side walls 64A, 64B, which are located between walls 58, 60 at opposite ends of the respective groove 54.

FIG. 6B is a schematic top view of groove 54A, which is similar to the other grooves 54. FIG. 6C is a schematic cross-sectional view of body 50 taken along line 5C-5C in FIG. 6A. As shown in FIGS. 5A and 5B, walls 58 and 60 are separated by a first width W_{G} at outer surface 52 and taper to at a junction 62. As shown in the top view of FIG. 6B, junction 62 is curvilinear along a bottom surface of aperture 54A and may define, for example, a curvature similar to the curve of wall 58 or wall 60 along outer surface 52 of body 50. Unlike junction 22 between walls 18 and 20 of apertures 14 (FIG. 1-2D), walls 58 and 60 meet at a substantially sharp point to define a sharp junction 62. However, in other embodiments, junction 62 may be rounded, similar to junction 22.

Walls 58, 60 are oriented at an angle A_{G} relative to each other. Angle A_{G} may be selected such that when body 50 is rotated in a first direction, as indicated by arrow 64 (FIG. 6C), wall 60 defines a surface that is inclined into the cavity defined by groove 54A. In some embodiments, angle A_{G} is about 20° to about 160°, such as about 45° to about 135°. Just as with body 40 (FIG. 5), body 50 defines an opening 68 that is configured to receive stem 12. Alternatively, stem 12 and body 50 may define an integral unit.

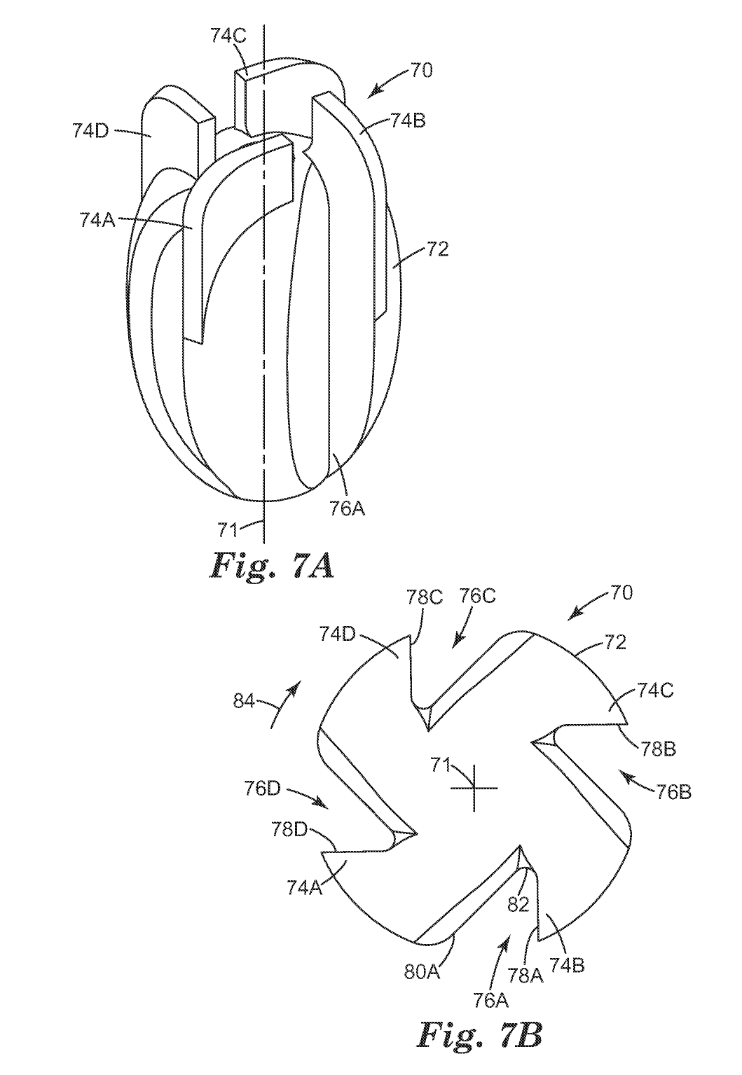

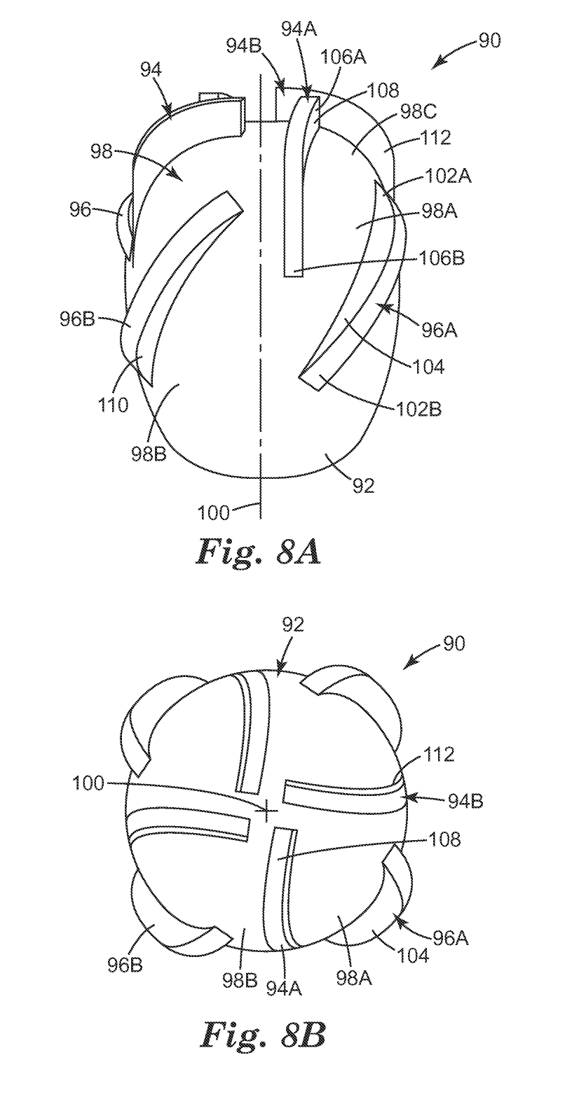

FIGS. 7A and 7B illustrate schematic perspective and top views of another embodiment of body 70, which defines rounded outer surface 72. A plurality of dividing members 74A-74D and grooves 76A-76D define sample acquisition regions for obtaining and retaining a sample from a sample source. Dividing members 74A-74D and grooves 76A-76D are symmetrically arranged around a center axis 71 of body 70. In some embodiments, center axis 71 may be substantially parallel to a longitudinal axis of stem 12 (FIG. 1) when body 70 is coupled to stem 12.

As shown in FIG. 7B, groove 76A, which is representative of the other grooves 76B-76D, includes first wall 78A and second wall 80A, which is oriented substantially nonparallel to first wall 80A. First wall 78A is substantially orthogonal to walls 78B and 78D of adjacent grooves 76B and 76D, respectively. Similarly, wall 78B of groove 76B is substantially orthogonal to walls 78A and 78C of adjacent grooves 76A and 76C, respectively, and wall 78C of groove 76C is substantially orthogonal to walls 78B and 78D of adjacent grooves 76B and 76D, respectively.

Walls 78A-78D are generally aligned with dividing members 74A-74D, respectively, such that dividing members 74A-74D are extensions of walls 78A-78D that extend from body 70. Accordingly, dividing members 74A-74D are generally orthogonal to adjacent dividing members. Dividing members 74A-74D extend from outer surface 72 of body 70 and help scrape or otherwise abrade sample particles from a surface of a sample source, which may help increase the quantity of sample obtained via one rotation of body 70 or the sample acquisition area of the sample source. In addition, dividing members 74A-74D may define additional sample acquisition regions for additional sample retention capacity. Because dividing members 74A-74D protrude from a side of body 70 other than the side in which grooves 76A-76D are positioned, dividing members 74A-74D also help device 70 acquire a sample from an irregularly shaped sample source, e.g., a sample source including one or more surfaces extending in more than one dimension. In one embodiments, dividing members 74A-74D protrude from outer surface 72 of body 70 a distance P of about 1 mm to about 2 mm, such as about 1.5 mm.

In some embodiments, dividing members 74A-D and grooves 76A-76D are shaped (e.g., via an extrusion manufacturing technique) to have a variable cross-section along its width W_{DM}. For example, dividing members 74A-D may have a cross-sectional size along its width W_{DM} that decreases away from outer surface 72, similar to a converging blade of a knife. Dividing members 74A-74D may also be flexible in some embodiments, which may allow dividing members 74A-74D to deform and conform to different sample surfaces when body 70 is rotated in one or both directions about center axis 71. Flexible dividing members 74A-74D may help remove particles of a solid sample, as well as a fluid or semi-fluid (e.g., a consistency of a gel) from a sample source, similar to a squeegee blade.

In order to acquire a sample from a source, such as sample surface 26 (FIG. 3), a user may rotate body 70 in a first direction, as indicated by arrow 84 in FIG. 7B. Just as with wall 20 of head 14 (FIGS. 1-3), wall 80A of groove 76A defines a sloped surface that helps draw a sample into groove 76A. A user may rotate body 70 in the first direction 84 while engaging outer surface 72 with the sample surface. Upon one full rotation in the first direction 84, grooves 76A-76D are each exposed to the sample surface and each have an opportunity to receive and retain a sample. When rotated in first direction 84, wall 80A of groove 76 defines a surface that is inclined into aperture 76A.

Although a body 70 including four dividing members 74A-74D and four grooves 76A-76D is shown in FIGS. 7A-7B, in other embodiments, a body of a sample acquisition device may include any suitable number of dividing members and grooves, which may or may not be equal in number. In addition, although grooves 76A-76D are open-ended, i.e., do not include sidewalls (e.g., sidewalls 64A and 64B of groove 54A shown in FIG. 6B), in other embodiments, grooves 76A-76D may include one or more sidewalls to further enclose the sample acquisition regions defined by grooves 76A-76D.

FIGS. 8A and 8B illustrate a schematic perspective view and top view, respectively, of another embodiment of body 90 of a sample acquisition device, which defines longitudinal axis 100. Body 90 may be coupled to or integrally formed with a holding member, such as a stem 12. Body 90 defines a rounded outer surface 92 and includes projections 94 and 96 extending (or protruding) from body 90 to define a plurality of sample acquisition regions 98. In the embodiment shown in FIGS. 8A-8B, projections 94, 96 extend from an outer surface 92 of body 90. In other embodiments, however, at least one of projections 94 or 96 may protrude from, e.g., an aperture defined by body 90. Projections 94, 96 may be separate from body 90 and coupled to body with a suitable coupling mechanism, e.g., with the aid of an adhesive, interlocking parts, ultrasonic welding, and the like. In other embodiments, projections 94, 96 may be integrally formed with body 90, e.g., via an injection molding technique.

Some sample acquisition regions 98 are defined by a projection 94, which may define a first wall, and an adjacent projection 96, which may define an opposing, second wall that is generally nonparallel to the first wall. In addition, some sample acquisition regions 98 are defined by the space between adjacent projections 94, as well as between adjacent projections 96.

Projections 96 are oriented at various angles relative to longitudinal axis 100 of body 90. Projection 96A, which is representative of the other projections 96, is curvilinear. First end 102A of projection 96A has a first circumferential position on outer surface 92 of body 90 and second end 102B has a second circumferential position that is different than the first circumferential position. Thus, the first and second ends 102A, 102B of projection 96A are laterally displaced from each other. Due to the curvilinear shape of projection 96A, projection 96A defines a surface 104 that is sloped toward sample acquisition region 98A to help draw a sample into region 98A when body 90 is rotated in a direction indicated by arrow 105 (FIG. 8B). Surface 104 of projection 96A may “scoop” sample particles into sample acquisition region 98A

As shown in FIG. 8B, projections 94 are oriented substantially orthogonal relative to each other. Projection 94A, which is representative of the other projections 94, is substantially planar, such that a first end 106A of projection 94A shares a circumferential position with second end 106B. Thus, a surface 108 defined by projection 94A is generally planar. In other embodiments, however, ends 106A, 106B of projection 94A may be laterally displaced, i.e., in the case of a rounded outer surface 92, have different circumferential positions.

First end 102A of projection 96A and second end 106B of projection 94A overlap in a longitudinal direction such that a sample acquisition surface 98A is defined between surfaces 104 and 108 of projections 96A and 94A, respectively. In addition, a sample acquisition region 98B is defined between surface 104 of projection 96A and an opposing surface 110 of projection 96B. Surfaces 104 and 110 may be oriented at substantially similar angles relative to longitudinal axis 100 of body 90, and, in some cases, surfaces 104 and 110 may be generally parallel to each other. Regardless of whether surfaces 104 and 110 are generally parallel or nonparallel, surface 104 of projection 96A defines a wall that provides a sloped surface into sample acquisition region 98B when sample is rotated in direction 105 about axis 100.

Projection 94B is adjacent to projection 94A and defines a surface 112 that is substantially orthogonal to surface 108 of projection 94A. A space between surfaces 108 and 112 defines a sample acquisition region 98C. In embodiments in which projections 94 define angled surfaces, rather than surfaces that are substantially parallel to a plane in which longitudinal axis 100 of body 94 lays.

While outer surface 92 and projections 94, 96 may be designed such that they exhibit a surface energy that supports capillary action, body 90 acquires a sample primarily by abrasive action that results when projections 94 and 96 engage with the sample surface. Capillary force exhibited by sample acquisition regions 98 of body 90 may be minimal when compared to the capillary force exhibited by apertures 16 of body 14 (FIGS. 1-3).

Just as with dividing members 74A-74D of FIGS. 7A-7D, in some embodiments, projections 94 and/or 96 may have a variable cross-section. In addition, in some embodiments, at least some of projections 94 and 96 may also be flexible, which may allow projections 94 and 96 to deform and conform to different sample surfaces when body 90 is rotated in one or both directions about center axis 100. Compared to relatively rigid projections, a device including substantially flexible projections 94, 96 (or dividing members 74A-D) may accommodate irregular shaped sample surfaces, such as a nasal cavity of a human patient. In addition, a sample acquisition device including a body 120 with at least one substantially flexible projection 94, 96 provides a single device that may accommodate a plurality of different shaped sample surfaces (i.e., a surface of a sample source), which may increase the usefulness of the sample acquisition device. For example, different patients may have different shaped nasal cavities. A device including body 120 with at least one substantially flexible projection may help personalize the shape of body 120 to the patient's nasal cavity.

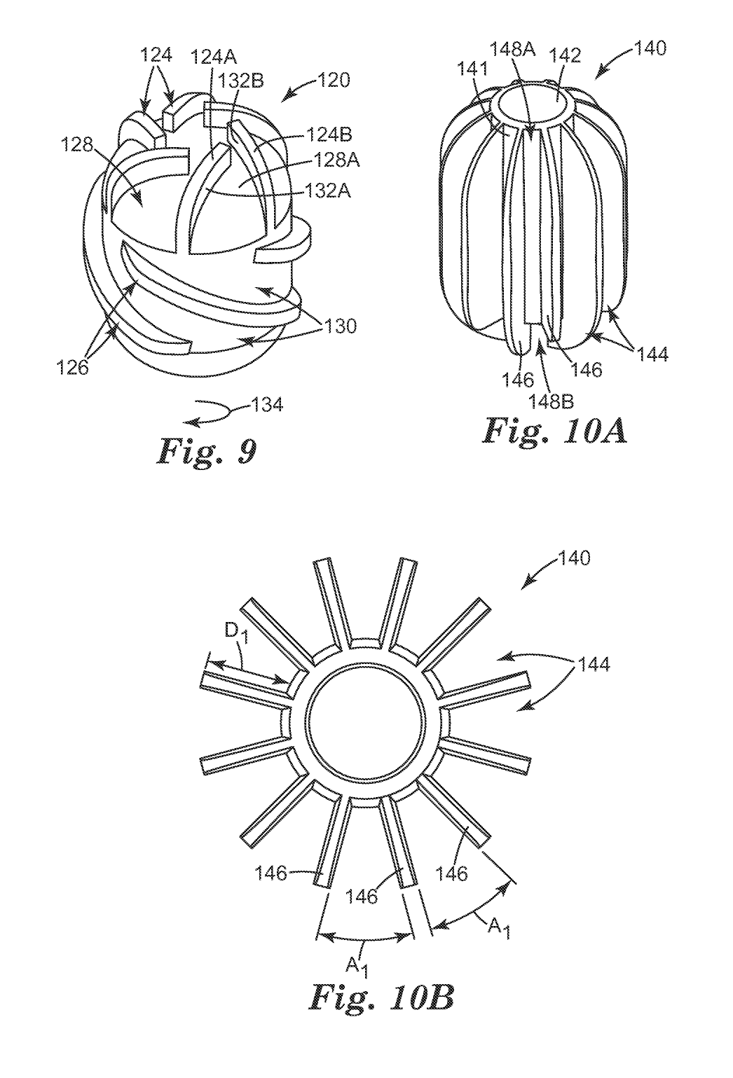

FIG. 9 is a schematic perspective view of another embodiment of body 120, which includes a rounded outer surface 122 and a plurality of projections 124 and 126. Body 120 is similar to body 90 of FIGS. 8A-8B. However, a longitudinal position of projections 124, 126 do not overlap. Accordingly, body 120 includes a plurality of sample acquisition regions 128 defined between adjacent projections 124 and a plurality of sample acquisition regions 130 defined between adjacent projections 126.

Each projection 124 is generally nonparallel to an adjacent projection 124. Accordingly, sample acquisition regions 128 defined between projections 124 include generally nonparallel walls that are defined by adjacent projections 124. In the embodiment shown in FIG. 9, projections 124 define substantially nonplanar surfaces. For example, surface 132A of projection 124A is substantially nonplanar. An opposing surface 132B of an adjacent projection 124B is also nonplanar such that when body 120 is rotated in a first direction, as indicated by arrow 134, surface 132A defines a surface that is sloped into the sample acquisition region 128A defined between projections 124A and 124B. The other projections 124 may define similar surfaces.

Each projection 126 is generally nonparallel to an adjacent projection 126. Accordingly, sample acquisition regions 130 defined between projections 126 include generally nonparallel walls that are defined by adjacent projections 126. Just as with projections 124, projections 126 define surfaces that define an inclined surface into the respective sample acquisition region 130.

Just as with dividing members 74A-74D of FIGS. 7A-7D, in some embodiments, projections 124 and/or 126 may be shaped to have a variable cross-section. In addition, in some embodiments, at least some of projections 124 and 126 may also be flexible, which may allow projections 124 and 126 to deform and conform to different sample surfaces when body 120 is rotated in one or both directions about its center axis.

FIGS. 10A-10B are a schematic perspective view and top view, respectively, of another embodiment of a body 140 of a sample acquisition device, which includes an opening 142 to couple to a holding member, such as stem 12 (FIG. 1). Body 140 is similar to body 50 of FIGS. 6A-6C. In particular, body 140 defines a plurality of grooves 144, where each groove is define at least in part by adjacent walls 146, where each wall is oriented substantially nonparallel to an adjacent wall 146. In some embodiments, angle A_{I} between adjacent walls 146 and 146 may be between about 20° to about 160°, such as about 45 to about 135°.

In contrast to grooves 54 of body 50 (FIGS. 6A-6C), however, walls 146 of grooves 144 are substantially similar in size and configuration. For example, each wall 146 extends a substantially equal length D_{I} from an outer surface 141 of body 140. In addition, in contrast to grooves 54 of body 50 (FIGS. 6A-6C), grooves 144 do not include sidewalls. Thus, grooves 144 define open ends 148A, 148B.

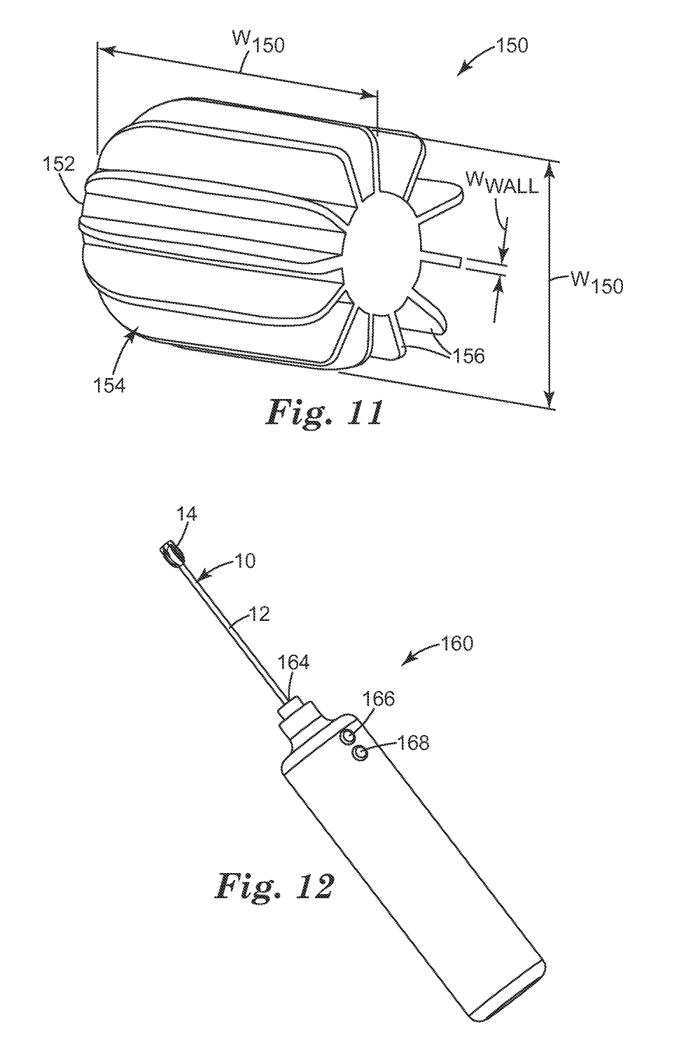

FIG. 11 is a schematic perspective view of another embodiment of body 150, which includes an opening 152 configured to couple to a holding member, and a plurality of grooves 154. Each groove 154 is defined at least in part by adjacent walls 156, where each wall is oriented substantially nonparallel to an adjacent wall 156. Body 150 is similar to body 140 of FIGS. 10A-10B. However, walls 156 of body 150 define a substantially planar top surface 158, rather than a curvilinear profile, as with walls 146 of body 140.

As previously described, in order to acquire a sample with a sample acquisition device including a body defining one or more sample acquisition regions with at least a first wall and a second wall that is nonparallel to the first wall, a user may rotate the body in a particular direction. The user may manually rotate the body or rotate the body with the aid of a device. FIG. 12 is a schematic perspective view of device 160 that is configured to receive a holding member of a sample acquisition device, such as stem 12 (FIG. 1) and automatically rotate the sample acquisition device in a first direction to obtain a sample from a sample source. Device 160 is also configured to rotate a sample acquisition device in a second direction that is substantially opposite to the first direction to release the sample from the body of the sample acquisition device.

While sample acquisition device 10 and body 14 (FIGS. 1-3) are primarily referred to throughout the description of FIG. 12, in other embodiments, device 160 may be useful for rotating a sample acquisition device including a holding member and any of the other bodies defining one or more sample acquisition regions that include a surface that is sloped into the region, such as body 40 (FIGS. 5A-5B), body 50 (FIGS. 6A-6B), body 70 (FIGS. 7A-7B), body 90 (FIGS. 8A-8B) or body 120 (FIG. 9). Device 160 may be useful for controlling the speed with which a user rotates body 14 relative to the sample source. For example, device 160 may include preset speed settings that are suitable for respective types of sample sources. The speed of rotation may affect the quantity of sample that is received and retained in apertures 16.

In the embodiment shown in FIG. 12, stem 12 may be introduced an opening 164 defined by the device 160. Device 160 may couple to stem 12 via any suitable technique, such as by a mechanical mechanism that engages stem 12, by vacuum force, interference fit between a portion of device 160 and stem 12, and the like.

Once secured in opening 164, stem 12 is coupled to a motor of device 160. The motor may be, for example, an electric motor that is controlled by a processor. A user may depress button 166 in order to activate the motor and rotate stem 12 in the first direction 17A (shown in FIG. 1), e.g., to acquire a sample from a sample source. Button 166 may be coupled to a microprocessor, such that upon depression of button 166, the processor generates an electrical signal that causes the motor to rotate stem 12 in the first direction 17A. In one technique for acquiring a sample, a user may place body 14 in contact with a sample source and subsequently depress button 166 to begin rotating body 14. Alternatively, the user may depress button 166 prior to placing body 14 in contact with the sample source.

If rotation of body 14 in the second direction 17B (FIG. 1) is desired, e.g., to release the sample from body 14, the user may depress button 168. Again, upon depression of button 168, a microprocessor of device 160 may generate an electrical signal that causes the motor to rotate stem 12 in the second direction 17B. The motor may be activated as long as button 166 or button 168 is depressed. Alternatively, the user may depress one of buttons 166, 168 a first time to activate the motor and depress the respective button 166, 168 or an “off” button a second time to deactivate the motor. In some embodiments, device 160 may include a user interface that permits a user to control the speed of rotation of stem 12. Different rotation speeds may be desirable for different types of sample acquisition device bodies, as well as different types of sample sources.

In other embodiments, device 160 may include other mechanisms for activating the motor and selecting a direction of rotation. For example, device 160 may include a switch that is movable, where different positions of the switch are associated with different directions of rotations and, in some cases, speeds of rotation. As another example, device 160 may include a touch screen display that defines selectable regions associated with different directions of rotation and, in some cases, speeds of rotation.

### Example 1

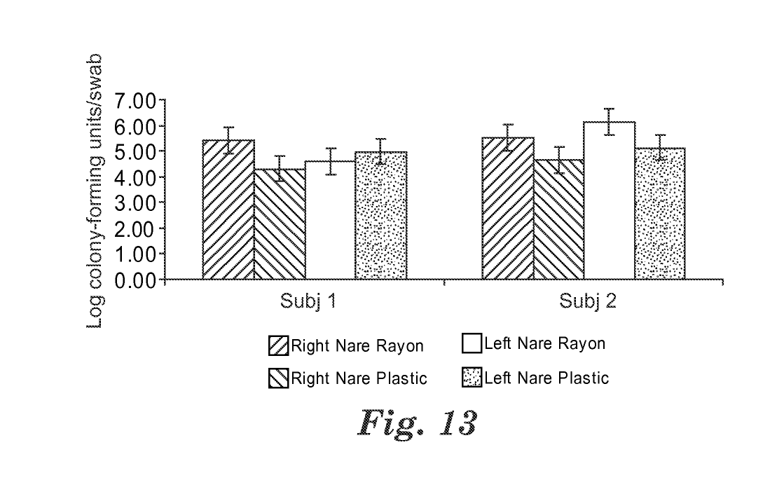

FIG. 13 illustrates the results of an experiment comparing the quantity of sample recovered (measured in log transformed data for colony forming units (CFU)) with two different sample acquisition devices from two different subjects. For each human subject, a conventional rayon tipped swab applicator and a sample acquisition device including body 150 (FIG. 11) including plurality of grooves 154 were placed in contact with tissue in the right and left anterior nare of the subject and the quantity of bacteria recovered from the respective devices was determined. In the experiment, opening 152 of body 150 had a diameter of about 1.91 mm (about 0.075 inches), and body 150 had 12 walls 156, each having a width W_{WALL} (shown in FIG. 11) of about 0.43 mm (about 0.017 inches). A length L₁₅₀ (shown in FIG. 11) of body 150 was about 11.43 mm (about 0.45 inches), and a greatest width W₁₅₀ (shown in FIG. 11) of body 150 was about 9.65 mm (about 0.38 inches). The conventional swab included a rayon bud at the end of an elongated stem, where the rayon bulb had a length of about 5 to 6 mm and defined a tapering teardrop shape with a greatest diameter of about 15 mm.

For the right nare of each subject, a rayon swab was introduced into the right nostril a sufficient amount to introduce the rayon tip into the nostril, approximately 1 cm. The rayon swab was rotated approximately three complete rotations relative to the mucosal surface and then withdrawn from the nostril. After introducing the rayon swab into the nostril, body 150 was introduced into the right nostril a sufficient amount to introduce body 150 into the nostril, approximately 1 cm, and rotated approximately three complete rotations relative to the mucosal surface. Similar techniques were used to acquire samples in the left nostril of the subject with a different rayon swab and different device including body 150.

After sample collection, the conventional rayon swabs and bodies 140 were placed into separate sterile 15 milliliter (mL) polypropylene centrifuge tubes. In order to extract the sample from the devices, 1000 microliters (μL) of a phosphate buffer saline (PBS), 10 mM sodium phosphate, 150 millimol (mM) sodium chloride, pH 7.5 (PBS) solution including 0.05% by volume of Tween 20 (PBS-Tween 20) was introduced into each polypropylene centrifuge tube containing either a rayon swab or a body 150.

Each polypropylene centrifuge tube containing a sample acquisition device was vortexed using a high setting of the VWR Vortex Mixer (120 Volts, 50/60 Hertz, 75 Watt) (VWR International, Batavia, Ill.). The devices were then removed from the respective centrifuge tubes and 1:10 serial dilutions in a PBS-Tween 20 buffer solution were performed. The swab extract solutions and its dilutions were plated in duplicate onto separate sheep blood agar (SBA) plates (Hardy Diagnostics, Santa Maria, Calif.). The plated samples were incubated at approximately 37 degrees Celsius (plus or minus one degree Celsius) for approximately 48 hours. After incubation, the plates were examined for growth. Plates in the dilution series having a range of about 25 CFU to about 250 CFU were counted. A total plate count for all colony types along with the dilution are shown in FIG. 13.

The results shown in FIG. 13 suggest that a sample acquisition device including body 150 has a sample acquisition performance similar to the conventional rayon swab.

Various embodiments of the invention have been described. These and other embodiments are within the scope of the following claims. Reference to the orthogonal x-y-z axes throughout the present disclosure is used to aid the description of sample acquisition devices and is not intended to limit the scope of the present invention. In addition, in each the embodiments described herein, stem 12 may define an inner lumen that is in fluid communication with the sample acquisition regions, regardless of whether the sample acquisition regions are defined by apertures or by projections.

While reference is made to first and second directions of rotation of each of the sample acquisition devices described above, the invention is not so limiting. A user may acquire a sample with the sample acquisition device, release a sample from the sample acquisition device, or may otherwise handle the sample acquisition devices using any suitable technique. For example, the user may rotate the bodies of the devices in the opposite directions described above in order to acquire a sample. As another example, the user may move the sample acquisition device relative to the sample site in a non-rotational pattern or another irregular pattern.

1. A sample acquisition device comprising:
a stem; and
a body coupled to the stem and defining a plurality of sample acquisition regions, wherein at least one of the sample acquisition regions is defined between at least a first wall and a second wall oriented nonparallel to the first wall.

2. The sample acquisition device of claim 1, wherein the body defines a plurality of apertures, each aperture defining one of the plurality of sample acquisition regions.

3. The sample acquisition device of claim 1, wherein the body defines a rounded outer surface.

4. The sample acquisition device of claim 3, wherein the rounded outer surface is at least partially spherically-shaped.

5. The sample acquisition device of claim 3, wherein the rounded outer surface has a radius that varies along the longitudinal axis of the stem to define a curvature.

6. The sample acquisition device of claim 3, wherein the rounded outer surface includes a proximal portion in which a radius of the body increases and a distal portion in which the radius of the body decreases in a direction toward a distal end of the body.

7. The sample acquisition device of claim 3, wherein at least two of the sample acquisition surfaces are positioned on opposite sides of the rounded outer surface.

8. The sample acquisition device of claim 1, wherein at least one of the first wall or second wall is curvilinear.

9. The sample acquisition device of claim 1, wherein the first wall is oriented at an angle of about 20° to about 160° relative to the second wall.

10. The sample acquisition device of claim 9, wherein the first wall is oriented at an angle of about 45° to about 135° relative to the second wall.

11. The sample acquisition device of claim 1, wherein the second wall defines an inclined surface into a respective one of the sample acquisition regions when the body is rotated in a first direction relative to a sample acquisition surface.

12. The sample acquisition device of claim 1, wherein the first wall and second wall define a junction, and the first wall is substantially radially aligned with the junction.

13. The sample acquisition device of claim 1, wherein the first wall and second wall define a junction, wherein the junction comprises a round surface.

14. The sample acquisition device of claim 1, wherein the plurality of sample acquisition regions are configured to retain a maximum sample volume of 10 microliters to about 1000 microliters.

15. The sample acquisition device of claim 1, wherein at least one of the first wall or the second wall extends from the body.

16. The sample acquisition device of claim 15, wherein at least one of the first wall or the second wall comprises a first end and a second end that have different circumferential positions on a rounded outer surface of the body.

17. The sample acquisition device of claim 1, wherein the body defines a plurality of grooves extending in a direction substantially along the longitudinal axis of the stem, each groove defining at least one of the sample acquisition regions.

18. The sample acquisition device of claim 17, wherein the first and second walls have substantially similar configurations.

19. The sample acquisition device of claim 1, wherein the body comprises an injection molded structure.

20. A sample acquisition device comprising:
a stem defining a longitudinal axis;
a body coupled to the stem and defining a plurality of apertures disposed at various lateral positions around the body, wherein at least one of the apertures comprises at least a first wall and a second wall, wherein the second wall defines a surface that is inclined into the respective aperture when the body is rotated in a first direction about the longitudinal axis of the stem.

21. The sample acquisition device of claim 20, wherein at least one of the first wall and the second wall extends from an outer surface of the body.

22. The sample acquisition device of claim 20, wherein the body comprises a round surface and the plurality of apertures disposed at various circumferential positions of the round surface.

23. The sample acquisition device of claim 20, wherein the first wall defines a plane that is substantially parallel to a plane in which the longitudinal axis of the stem lays.

24. The sample acquisition device of claim 20, wherein the second wall defines a plane that is substantially nonparallel to a plane in which the longitudinal axis of the stem lays.

25. A method comprising:
placing a body of a sample acquisition device in contact with a sample source to acquire a sample, the body defining a plurality of sample acquisition regions, wherein at least one of the sample acquisition regions comprises a first wall and a second wall oriented nonparallel to the first wall; and
rotating the body relative to the sample source in a first direction to acquire the sample in at least one of the sample acquisition regions.

26. The method of claim 25, further comprising:
withdrawing the body from the sample source; and
rotating the body in a second direction to release the sample from the sample acquisition device, wherein the second direction is substantially opposite the first direction.

27. The method of claim 25, further comprising at least partially submerging the body in a rinse fluid prior to rotating the body in the second direction.
